(19) United States
(12) Patent Application Publication
(10) Pub. No.: US 2004/0076403 A1
(43) Pub. Date: Apr. 22, 2004

(54) Method and apparatus for selecting television programs from a database for viewing or recording

(76) Inventor: Roy J. Mankovitz, Calabasas, CA (US)

Correspondence Address: CHRISTIE, PARKER & HALE, LLP, 350 WEST COLORADO BOULEVARD, SUITE 500, PASADENA, CA, 91105, US

(21) Appl. No.: 10/607,450

(22) Filed: Jun. 26, 2003

Related U.S. Application Data
(63) Continuation of application No. 09/299,489, filed on Apr. 26, 1999, now abandoned.
Application No. 09/299,489 is a continuation-in-part of application No. 08/031,246, filed on Mar. 12, 1993, now abandoned.

(51) Int. Cl. H04N 5/76; H04B 1/18

(52) U.S. Cl. 386/83; 348/731; 455/186.2

(57) ABSTRACT

A large database of available television schedule information and a computer for searching the database are located at a site remote from television user terminals that have a television tuner. The database of television schedule information includes program selection criteria and program identification data and the computer is programmed to search the database. The computer at the remote site selects television programs that meet user program selection criteria for viewing or recording at the user terminals.

### CROSS-REFERENCE TO RELATED APPLICATIONS

This is a continuation of application Ser. No. 09/299,489 filed on Apr. 26, 1999, which is a continuation-in-part of application Ser. No. 08/031,246 filed Mar. 12, 1993. The disclosures of these applications are incorporated fully herein by reference.

### BACKGROUND OF THE INVENTION

This invention relates to television and more particularly to selection of television programs for viewing or recording.

The choice of available television programs is expanding at an explosive rate. As a result, it is difficult for television users to make an informed decision about the programs to view in real time or to record for later viewing. Interactive electronic program guides resident in user television, cable box, or VCR terminals help users to sort through television programs, but microprocessor and RAM limitations restrict the ability of users to select television programs comprehensively and methodically.

### SUMMARY OF THE INVENTION

According to the invention, a large database of available television schedule information and a computer for searching the database are located at a site remote from television user terminals that have a television tuner. The database of television schedule information includes program selection criteria and program identification data and the computer is programmed to search the database. The computer at the remote site selects television programs that meet user program selection criteria for viewing or recording at the user terminals.

Specifically, the program selection criteria are transmitted from a user terminal to the remote site. At the remote site, the database is searched for television schedule information meeting the transmitted program selection criteria to retrieve from the database the program identification data thereof. The retrieved program identification data is transmitted to the user terminal, where it is stored for viewing or recording television programs.

### DESCRIPTION OF THE DRAWINGS

The features of specific embodiments of the best mode contemplated of carrying out the invention are illustrated in the drawings, in which:

FIG. 1 is a schematic block diagram of apparatus illustrating an embodiment of the invention; and

FIG. 2 is a flow diagram illustrating the operation of the apparatus of FIG. 1.

### DETAILED DESCRIPTION OF A SPECIFIC EMBODIMENT

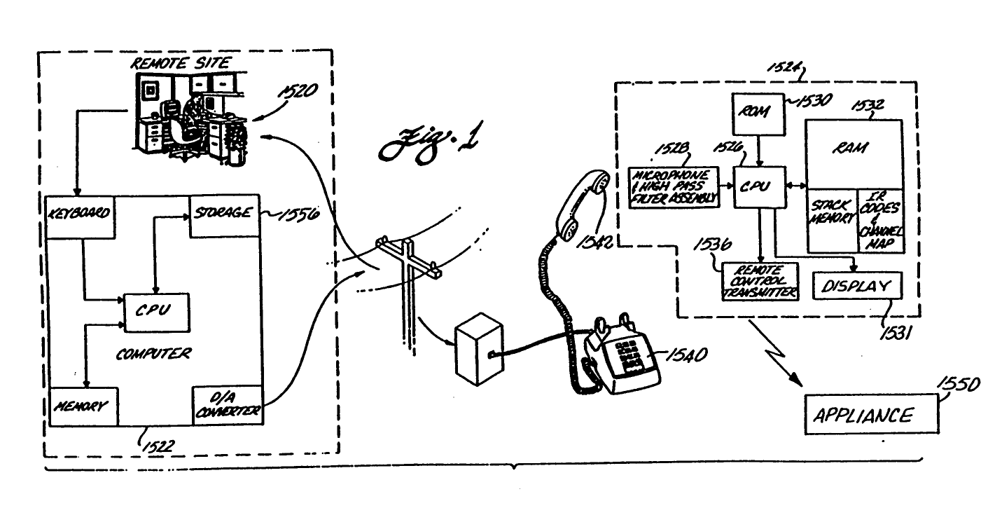

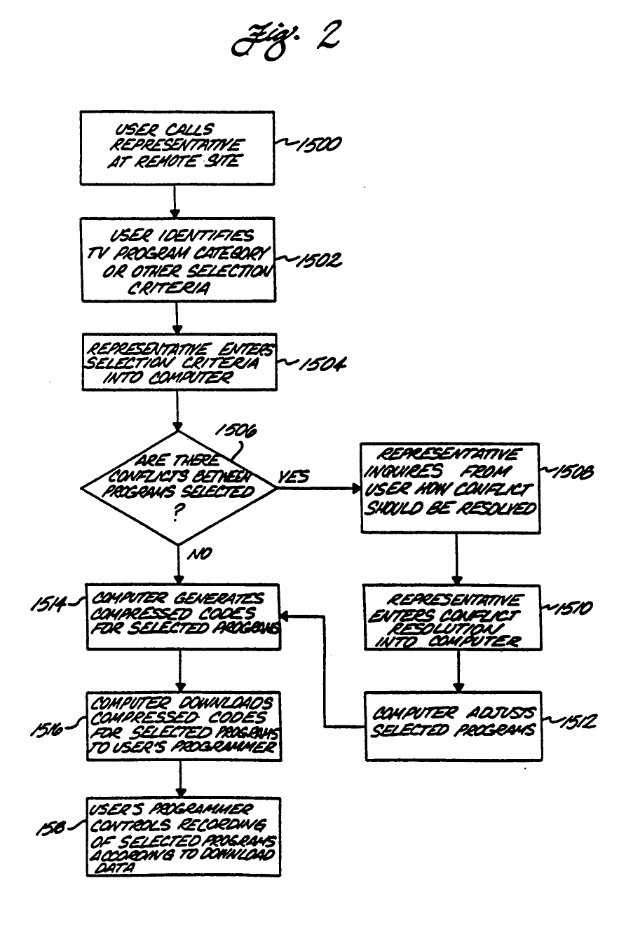

Exemplary apparatus for practicing one embodiment of the invention is shown in FIG. 1 and its operation is explained in connection with FIG. 2. With reference to FIG. 1, a user terminal in the form of a downloadable programmer 1524 functions with an appliance 1550 that has a television tuner, such as a television receiver or VCR. The user terminal has a RAM 1532 in which downloaded information to control appliance 1550 is stored. The user terminal is connected to a remote site by a communications link such as a telephone 1540 through which a user transmits program selection criteria to the remote site. At the remote site a customer service representative 1520 enters the program selection criteria into a computer 1522 that has a mass storage medium 1556 such as a disk file. A database of television schedule information including program selection criteria and program identification data is resident in storage medium 1556. Computer 1522 searches the database for the entered program selection criteria and retrieves the program identification data thereof. This program identification data is transmitted over telephone 1540 back to the user terminal where it is stored in RAM 1532 for viewing or recording of selected television programs.

With reference to FIG. 2, in block 1500, the user calls customer service representative 1520 (FIG. 1) on the telephone, either on a pay-per-minute or pay-per-call 900 number, toll-free 800 number or regular toll number. In block 1502, the user orally gives the representative program selection criteria. Such criteria include the type of show, such as situation comedies, dramas, action shows, mysteries, police or detective shows, real life rescue, emergency or police shows, game shows, news magazines, daily news programs, documentaries, sports events, movies, etc. Further criteria include more specific descriptions such as movies or shows starring a particular actor or actress or directed by a certain director (e.g. “all Humphrey Bogart movies”), sporting events involving a particular team and/or a particular sport (e.g. “all U.C.L.A. basketball games”), a show that may be on multiple times a week on different channels (e.g., “all episodes of ‘I Love Lucy’ on this week”).

In block 1504, the representative enters the program selection criteria given by the user in block 1502 into computer 1522. The computer includes a large database of television programs to be broadcast in the future, stored in mass storage 1526. The computer then searches the database for television programs that match the information entered by the representative and retrieves program identification data such as the channel, date, time-of-day and length data for each program matching the entered program selection criteria. In block 1506, the computer automatically checks the date, time-of-day and length data for all the programs retrieved in the database search for time conflicts between programs that overlap each other.

If there is a time conflict, the computer alerts the representative that there is a time conflict and the programs that are involved. In block 1508, the representative informs the user of the time conflict and the programs that are conflicting. The user then decides which of the conflicting programs he or she wishes to record or view. Alternatively, the user chooses to have only the non-conflicting portion of a program that partially conflicts with another program recorded or viewed to avoid the conflict. For example, if two programs are selected that both begin at 8:00 pm on Sunday, but one lasts one hour and the other lasts two hours, the user can choose to record the one hour program and the second hour of the two hour program. The user tells the representative how to resolve the conflict and, in block 1510, the representative enters this information into the computer, which adjusts the selected programs accordingly, in block 1512.

In one embodiment, in block 1514, the computer converts the channel, date, time-of-day and length of each of the programs remaining after the search of the database and after resolving time conflicts, if any, into G-codes for use by downloadable programmers that perform the functions of the instant programmer. In FIG. 1, the downloadable programmer is represented as programmer 1524, which in addition to RAM 1532, has a CPU 1526, a microphone and high pass filter 1528, a remote control transmitter 1536 (which is usually an infrared emitter), a ROM 1530 for storing the operating program, and a display 1531. RAM 1532 includes a stack memory for storing the downloaded program identification data of the selected programs that meet the selection criteria, preferably as CDTL information. In block 1516, the computer downloads the G-codes over a telephone line to telephone 1540, which delivers the G-codes to programmer 1524.

In another embodiment, the blocks 1514 and 1516 are replaced by a block (not shown) in which the computer downloads data representing the channel, date, time-of-day and length of each of the programs selected by the search of the database and modified to resolve time conflicts, if any, over a telephone line in uncompressed form to programmer 1524.

After program data is downloaded to a telephone downloadable programmer, and decoded into channel, date, time-of-day and length, if G-codes were downloaded, the CDTL data is stored in the stack memory of RAM 1532. The control of the recording of the programs according to this data is performed in same manner as performed by the various telephone downloadable programmers described above.

In an alternative embodiment, the program data is downloaded to the telephone downloadable programmers for control of a television or cable box only, rather than for control of a video recorder. With this embodiment, the user is able to use a telephone downloadable programmer to simply change the channel of his or her television or cable box to assure that an important show is not missed because the user forgets what time it is or becomes engrossed in another show or simply because the user does not want to bother having to change channels manually.

The format of the database file at the remote site to store the great amount of information about the future television broadcasts of television programs and the database program (engine) used to manipulate and search the database file can be any well known database format and corresponding database engine. In the preferred embodiment, the database format used consists of a series of records, each having a predetermined set of fields that is the same as the set of fields in every other record in the database. Each television program corresponds to one record of the database. Each record contains fields for the title, channel, date, starting time-of-day and the length of the program. Further, each record includes a series of boolean fields, each field representing a certain category of television program, such as situation comedy, romantic movie, sports program, etc. The advantage of this embodiment is that many different categories may be easily represented and searched, while taking up little space. This embodiment takes up little space because even though there may be over a hundred different category fields, a boolean field usually takes up only one bit or at most one byte of space for each record in most database file formats. The small size of each category field also facilitates rapid searching through the database for all the programs in a certain category. This embodiment also allows for multiple overlapping categories. For example, the database may have separate category fields for crime subject matter, comedy, and fiction. One television program may be a fictional comedy about crime, thus containing a “true” value in all three category fields. On the other hand, a program may be a real life drama about crime which only would contain a “true” value in one of these category fields, viz. the crime subject matter field.

In addition to the boolean category fields, each record includes several “people” fields. The contents of the “people” fields include characters in the program, actors and actresses, directors and writers involved with the creation of the program. Thus, if a user desires to program all programs involving certain people, be they characters, actors or creators of the program, the computer can search the “people” fields for this information. Alternatively, there can be separate fields for characters, actors and actresses, and creators of programs.

Each record also includes fields devoted to the violence and sexual content of the television program. In the case of motion pictures, a field for the rating by the Motion Picture Association is utilized. In every record, boolean fields for such descriptions as mild violence, explicit violence, brief nudity, nudity, profanity, adult situations, and sexual theme are included. Thus, programs can be selected or excluded from a search based on such general content information.

Each record of the database also includes an abstract that contains a brief description of the program. This allows a more detailed and extensive search, albeit more time consuming, of specific program content by searching all of the abstract fields for certain keywords or combinations of keywords.

The described embodiments of the invention are only considered to be preferred and illustrative of the inventive concept; the scope of the invention is not to be restricted to such embodiments. Various and numerous other arrangements may be devised by one skilled in the art without departing from the spirit and scope of this invention.

What is claimed is:

1. A method of selecting television programs for viewing or recording at a user terminal that has a television tuner, the method comprising the steps of:
transmitting one or more program selection criteria from the user terminal to a remote site where a database of television schedule information, including program selection criteria and program identification data, and a computer programmed to search the database are located;
searching the database for television schedule information meeting the transmitted program selection criteria to retrieve from the database the program identification data thereof;
transmitting the retrieved program identification data to the user terminal; and
storing the transmitted program identification data at the user terminal for viewing or recording television programs.

2. The method of claim 1, in which the user terminal is a VCR, the method additionally comprising the step of controlling the VCR to record programs identified by the program identification data.

3. The method of claim 1, in which the user terminal is a television receiver, the method additionally comprising the step of controlling the television receiver to display the programs identified by the program identification data.

4. The method of claim 1, in which both transmitting steps comprise establishing a telephone connection between the user terminal and the remote site.

5. The method of claim 1, in which the step of transmitting to the remote site comprises establishing a telephone connection from the user terminal to the remote site.

6. The method of claim 5, in which the step of transmitting to the user terminal comprises transmitting in a television signal.

7. The method of claim 1, in which the program identification data comprises CDTL information.

8. The method of claim 7, in which the CDTL information is compressed prior to the step of transmitting to the user terminal.

9. The method of claim 7, in which the CDTL information is uncompressed prior to the step of transmitting to the user terminal.

10. The method of claim 1, in which the program selection criteria include categories of television programs.

11. The method of claim 10, in which the categories overlap.

12. The method of claim 10, in which the database contains categories in a series of boolean fields.

13. The method of claim 1, in which the program selection criteria include people associated with television programs.

14. The method of claim 1, in which the program selection criteria include content ratings of television programs.

15. The method of claim 1, in which the database contains descriptions of television programs and the program selection criteria include key words in the descriptions.

16. The method of claim 1, in which the database is arranged so there is a separate record for each television program, each record comprises a plurality of fields, one or more fields of each record define the program information data, and one field of each record defines one of the program selection criteria.
